(19) United States
(12) Patent Application Publication
(10) Pub. No.: US 2007/0018349 A1
(43) Pub. Date: Jan. 25, 2007

(54) Tire mold and tread

(76) Inventors: Chinglin Pan, Mauldin, SC (US); Daniel Lefevre, La Roche Blanche (FR)

Correspondence Address: MICHELIN NORTH AMERICA, INC.;INTELLECTUAL PROPERTY DEPARTMENT, MARC BLDG 31-2, P.O. BOX 2026, GREENVILLE, SC, 29602, US

(21) Appl. No.: 11/188,572

(22) Filed: Jul. 25, 2005

(51) Int. Cl. B29C 35/00

(52) U.S. Cl. 264/219; 425/35; 264/326

(57) ABSTRACT

The present invention is a process for making an entire truck tire tread comprising the steps of securing tread mold segments comprising plates to a flat backing, placing a blank tread on the mold segments, and pressing the blank tread against the mold segments. The invention also comprises this process wherein the tread mold segments comprising plates are formed by the steps of machining at least one side of a plate so that the peak to peak variation of the plate surface is less than 5 microns, securing the plates to a flat backing; and machining a reverse tread pattern onto the secured plates. The present invention also comprises a process for making a mold for a tire tread comprising the steps of securing tread mold segments comprising plates of at least two different thicknesses to a flat backing, and machining a reverse tread pattern comprising ridges onto the secured plates, where the thickness of the plate under the ridge is chosen so that the width to height ratio of a ridge on a plate is not less than 1:10.

### FIELD OF THE INVENTION

The present invention is in the field of tire molds.

### BACKGROUND OF THE INVENTION

During the molding of the tire, it is necessary to be able to evacuate all the air which might be imprisoned between the tire introduced into the mold and the different parts of the mold. If the slightest pocket of imprisoned air remains between the mold and the tire, this will cause a molding defect which appears on the outer surface of the tire. Such molding defects are unacceptable both from the standpoint of the quality of the tire manufactured and from the standpoint of its aesthetic appearance. Now, it is known that it is impossible to assure total venting of a mold naturally, that is to say, by simply using the spaces between the different component parts of the mold in order to assure the evacuation of the air. Recourse is therefore had to various palliatives, one of which is of general use in the tire industry, namely the drilling of small vent holes wherever necessary in the mold.

When such vents are used, a trace of them is seen on the molded tire in the form of small protuberances of rubber which extend from the surface of the tire. It is known that, as soon as an interstice exceeds a size of 0.05 mm, it is capable of assuring the venting, but at the same time it permits a slight leakage of raw rubber. Now, it is impossible to effect drillings of a diameter of less than 0.05 mm economically. For this reason, one continues to see on most tires a trace of the small vent holes in the form of small protuberances extending from the surface of the tire.

### BRIEF DESCRIPTION OF THE DRAWINGS

FIG. 1 is an illustration of the tire tread mold of the present invention.

FIG. 2 is an illustration of one plate of the tire tread mold of the present invention.

FIG. 3 shows a tread made with the tire tread mold of the present invention.

FIG. 4 is an enlargement of the tread shown in FIG. 3.

### SUMMARY OF THE INVENTION

The present invention is a process for making an entire truck tire tread comprising the steps of securing tread mold segments comprising plates to a flat backing, placing a blank tread on the mold segments, and pressing the blank tread against the mold segments. The invention also comprises this process wherein the tread mold segments comprising plates are formed by the steps of machining at least one side of a plate so that the peak to peak variation of the plate surface is less than 5 microns, securing the plates to a flat backing; and machining a reverse tread pattern onto the secured plates.

The present invention also comprises a process for making a mold for a tire tread comprising the steps of securing tread mold segments comprising plates of at least two different thicknesses to a flat backing, and machining a reverse tread pattern comprising ridges onto the secured plates, where the thickness of the plate under the ridge is chosen so that the width to height ratio of a ridge on a plate is not less than 1:10.

### DETAILED DESCRIPTION OF THE INVENTION

The present invention is a process for making an entire truck tire tread comprising the steps of securing tread mold segments comprising plates to a flat backing, placing a blank tread on the mold segments, and pressing the blank tread against the mold segments. The invention also comprises this process wherein the tread mold segments comprising plates are formed by the steps of machining at least one side of a plate so that the peak to peak variation of the plate surface is less than 5 microns, securing the plates to a flat backing; and machining a reverse tread pattern onto the secured plates.

The present invention also comprises a process for making a mold for a tire tread comprising the steps of securing tread mold segments comprising plates of at least two different thicknesses to a flat backing, and machining a reverse tread pattern comprising ridges onto the secured plates, where the thickness of the plate under the ridge is chosen so that the width to height ratio of a ridge on a plate is not less than 1:10.

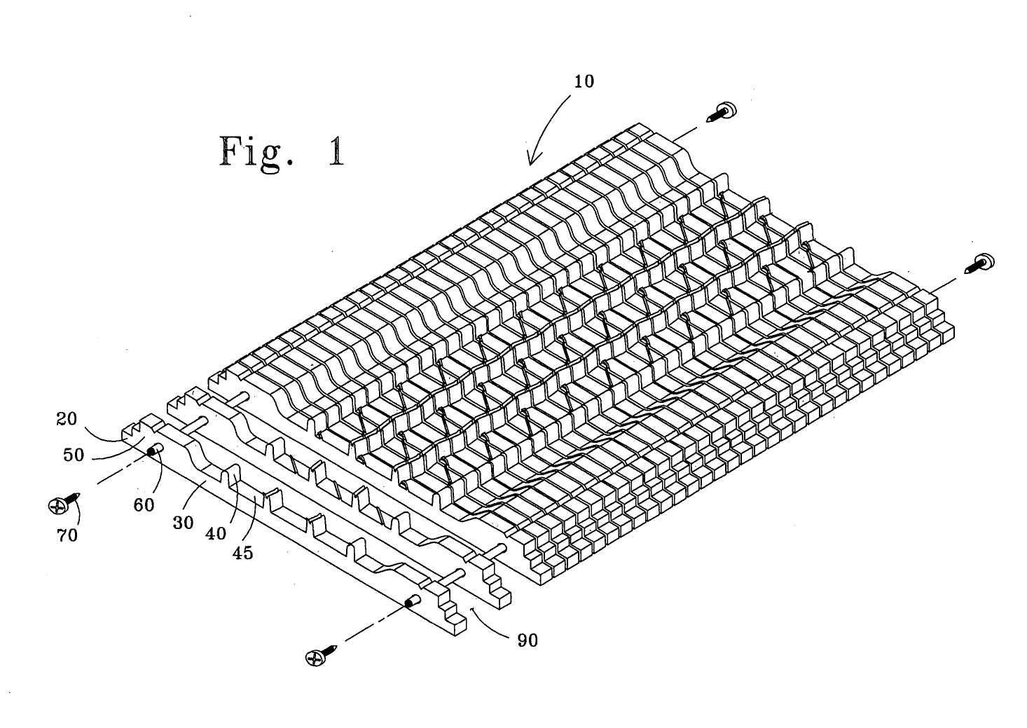

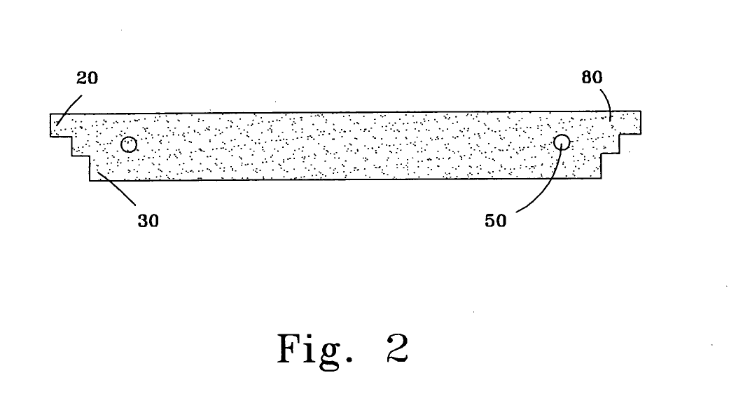

FIG. 1 shows one embodiment of a segment of the tire tread mold (10) of the present invention. Flat plates (20) are secured together, forming a segment of the complete mold. In this embodiment, the plates (20) are secured by means of rods (60) extending through apertures (50) in the plates. End piece (70) secures the plates together. A reverse of a tread pattern has been machined onto one side of the mold (10). This pattern comprises various ridges (40) and depressions (45). According to the present invention, the plates (20) begin as blanks, such as shown in FIG. 2. In one embodiment of the invention, the plates are made of aluminum approximately 10 millimeters thick. The plates are roughened on one or both of their major sides, so that the peak to peak maximum height difference on the machined surface is about 0.005 millimeters. This roughness permits venting of gases between the plates during the tread mold process, but is small enough to prevent the formation of flashing.

A tread pattern is then machined onto the clamped-together plates (see FIG. 1). One example of a reverse of a tread pattern is shown. The reverse tread pattern comprises ridges (40) and depressions (45). In one embodiment of the invention, the height to width ratio of a ridge is no greater than 10:1. This preserves the strength of the tread mold pattern. In another embodiment of the invention, the plates are of at least two different thicknesses. That way, plates can be selected such that a ridge supported by a plate has a height to width ratio no greater than 10:1. In other words, thin features in the tread mold do not lie across two plates.

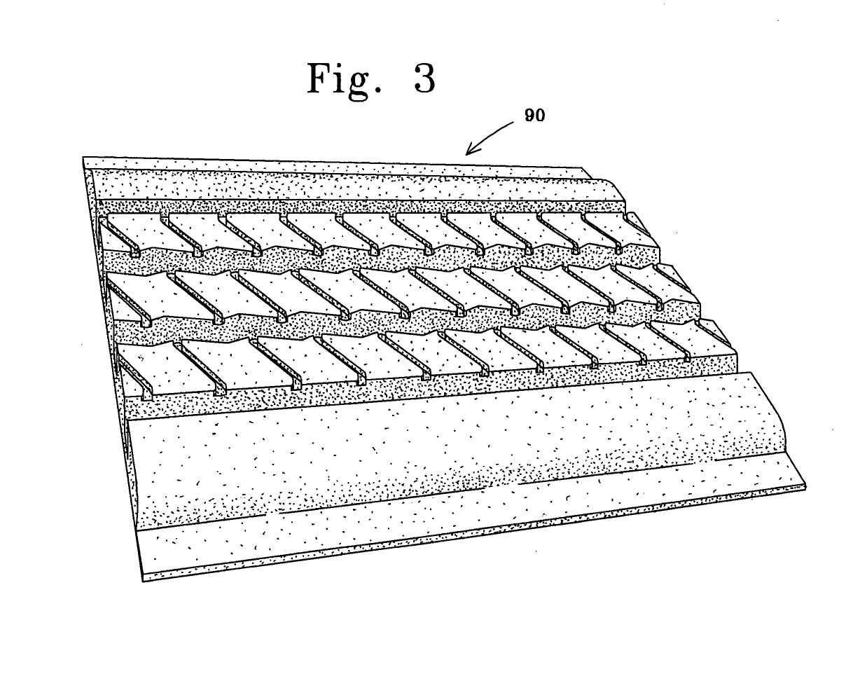

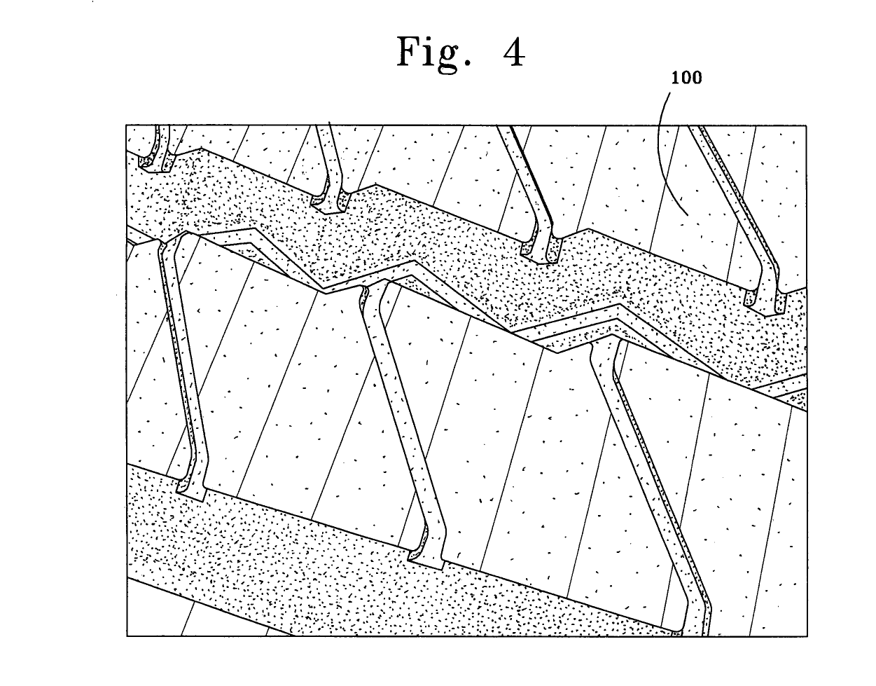

The segment shown would placed onto a flat backing (not shown), and placed in a press. A blank tread (not shown) would be placed on the mold, and the end result would be a tire tread such as shown in FIG. 3. FIG. 4 is an enlargement of the tread shown in FIG. 3.

FIG. 4 shows almost unobservable lines of flashing (100), less than 0.1 millimeter high. Thus, the use of the present invention results in a greatly improved tread appearance.

The invention may be further understood by means of the following non-limiting example.

### EXAMPLE 1

A mold was constructed for a 215/65R16XZE-SA tire tread. Both sides of 6061 aluminum plate (⅜″ or 9.525 mm) were roughened to permit venting, and clamped together. The tread pattern was machined into three sectors of tread (total length 889 millimeters). The mold face was then sandblasted. The sectors were secured in a press, and a total of seven cures were made. The process was then repeated.

FIG. 3 and FIG. 4 show the results of the process.

Venting performance: The testing sectors were placed in the middle of the press, which is the worst position for causing venting quality control issues. After all 14 cures, none of the treads made by the test sectors had any venting quality control deficiencies. Besides that, even the backside of the sculpture had no venting deficiencies for all test treads. This has been a venting problem for this particular sculpture. That means air pockets trapped on the backside of the tread may penetrate the rubber and vent through the gap in between the plates.

Tire aspect: The overall appearance is much better than a mono-block mold with vents made by a direct machining process. It looks the same as a new tire by the Michelin aspect standard. The stepping on the summit in-between the plates is minimal. They are visible, but not measurable.

Flashing: There was no flashing on one of the sectors with all plates machined on one side for the first curing test. There was no flashing on any of the 3 sectors for the second curing test. For that test, one sector had plates machined on one side, and other two sectors had plates machined on both sides.

The tread surface finish has the same quality as treads made by any other process. The misalignment in-between the sectors was minimal. They are visible, but not measurable. That implied that the accuracy of the sector length and CNC machine three-dimensional accuracy is good. We expect that the three-dimensional accuracy of the mold will be within several hundredths of a millimeter.

The summit has sharp corners; the aspect around the summit is much cleaner and neat looking. The minimum radius in between the groove wall and the tread surface is 1.0 mm. No visible steps were created using in different finish cutting tools. It is a common problem in the direct sculpture machining process. That is because all the finish tools are set into precision length and the spindle assembly of the CNC machine has compensation for thermal expansion.

We claim:

1. A process for making an entire truck tire tread comprising the steps of:
(a) securing tread mold segments comprising plates to a flat backing;
(b) placing a blank tread on the mold segments; and
(c) pressing the blank tread against the mold segments.

2. The process of claim 1, wherein the tread is greater than three meters in length.

3. The process of claim 1, wherein the tread mold segments comprising plates are formed by the steps of:
(a) machining at least one side of a plate so that the peak to peak variation of the plate surface is less than 5 microns.
(b) securing the plates to a flat backing; and
(c) machining a reverse tread pattern onto the secured plates.

4. A process for making a mold for a tire tread comprising the steps of:
(a) securing tread mold segments comprising plates to a flat backing;
(b) machining a reverse tread pattern onto the secured plates;
wherein the tread pattern comprises ridges, and the width to height ratio of the ridges is not less than 1:10.

5. The process of claim 4, wherein the plates comprise aluminum.

6. A tire tread mold comprising segments comprising plates secured to a flat backing, wherein some plates have widths greater than 2 millimeters different than other segments.

7. A tire tread comprising mold flashing wherein the flashing comprises lines less than 0.1 millimeter tall.

8. A mold for a tire tread comprising tread mold segments comprising plates of at least two different thicknesses.

9. The mold of claim 9, wherein the plates differ in thickness by at least 7 millimeters.

10. A process of making a mold for a tire tread comprising the steps of:
(a) securing tread mold segments comprising plates of at least two different thicknesses to a flat backing;
(b) machining a reverse tread pattern comprising the ridges onto the secured plates;
wherein the thickness of the plate under the ridge is chosen so that the width to height ratio of a ridge on a plate is not less than 1:10.
